(19) United States
(12) Patent Application Publication
(10) Pub. No.: US 2023/0138063 A1
(43) Pub. Date: May 4, 2023

(54) WASTE TONER STORAGE STRUCTURE DETACHABLE FROM CARTRIDGE

(71) Applicant: HEWLETT-PACKARD DEVELOPMENT COMPANY, L.P., Spring, TX (US)

(72) Inventors: Hyunwoo KIM, Seongnam-si (KR); Yongjae KIM, Seongnam-si (KR); Jaeseok YOO, Seongnam-si (KR)

(21) Appl. No.: 17/722,594

(22) Filed: Apr. 18, 2022

(30) Foreign Application Priority Data
Oct. 28, 2021 (KR) 10-2021-0145846

(51) Int. Cl. G03G 21/12; G03G 21/10; G03G 15/16; G03G 21/18

(52) U.S. Cl. CPC G03G 21/12; G03G 21/105; G03G 15/161; G03G 21/1814

(57) ABSTRACT

An example cartridge for an image forming apparatus, includes a frame, a photosensitive drum accommodated in the frame, a cleaner, a waste toner transfer part, and a waste toner storage part. The cleaner is to remove toner from an outer circumferential surface of the photosensitive drum. The waste toner transfer part is to transfer waste toner removed by the cleaner. The waste toner storage part is to store the waste toner transferred through the waste toner transfer part, and to be removable from the frame.

### BACKGROUND

An image forming apparatus may refer to a device that generates, prints, receives, and transmits image data. For example, the image forming apparatus may include a printer, a scanner, a copier, a fax machine, and a multi-function printer implemented by integrating a plurality of functions of such devices.

Such an image forming apparatus may include a toner cartridge to form a toner image on a print medium and a waste toner storage part to store waste toner generated after the toner image is formed on the print medium.

### BRIEF DESCRIPTION OF THE DRAWINGS

Various examples will be described below by referring to the following figures.

FIG. 1 is a perspective view of an image forming apparatus showing a state in which an image forming apparatus cartridge is separated from a case according to an example.

FIG. 2 is a perspective view of an image forming apparatus showing a state in which a waste toner storage part is separated from a photosensitive cartridge according to an example.

FIG. 3 is a perspective view of an image forming apparatus cartridge according to an example.

FIG. 4 is an exploded perspective view of an image forming apparatus cartridge according to an example.

FIG. 5 is a longitudinal cross-sectional view taken along line A-A′ in FIG. 1 according to an example.

FIG. 6 is a partial cross-sectional view of an image forming apparatus cartridge according to an example.

FIG. 7 is a view illustrating a state in which the waste toner storage part of FIG. 6 is moved upward according to an example.

FIG. 8 is a partial cross-sectional view illustrating a state in which the waste toner storage part of FIG. 7 is moved upward and an opening/closing member is rotated according to an example.

FIG. 9 is a partial cross-sectional view illustrating a state in which a waste toner storage part is moved forward and the opening/closing member is rotated according to an example.

FIG. 10 is a side view of an image forming apparatus cartridge showing a state in which a waste toner storage part is moved forward with the frame removed according to an example.

FIG. 11 is a side view of an image forming apparatus cartridge showing a state in which a waste toner storage part is moved upward with the frame removed according to an example.

FIG. 12 is an exploded perspective view of an image forming apparatus cartridge according to an example.

FIG. 13 is an exploded perspective view of an image forming apparatus cartridge according to an example.

### DETAILED DESCRIPTION

Hereinafter, examples will be described with reference to the accompanying drawings.

A component that is described as “connected”, “supported”, “fastened”, “mounted”, “removed” or “guided” to another component may be understood as being directly connected, supported, fastened, mounted, removed or guided to the latter component or that a third component may be interposed between the two components.

Certain terms used in the present specification are to describe various examples without limiting the present disclosure. An expression used in the singular encompasses the expression of the plural, unless it has a clearly different meaning in the context.

The terms used herein, including ordinal numbers such as “first” and “second” may be used to describe, and not to limit, various components. The terms are used to distinguish the components from one another.

The meaning of “including” refers to a specific characteristic, region, integer, operation, action, element and/or component, and use of the term is not to limit the existence or addition of other specific characteristic, region, integer, operation, action, element, component and/or group.

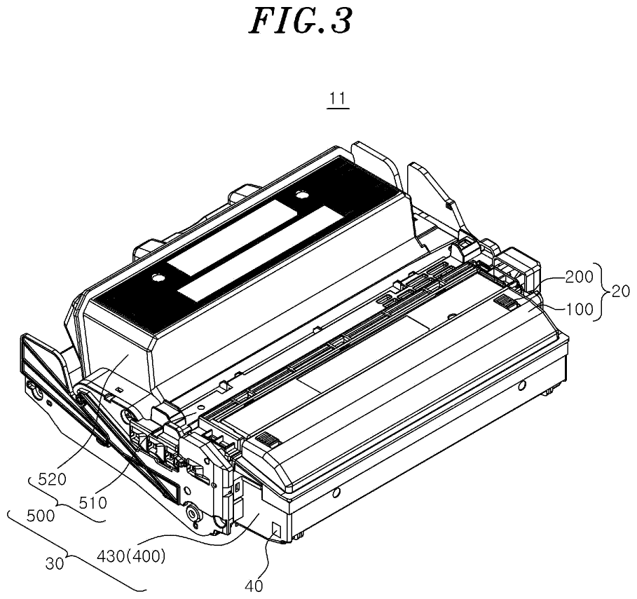

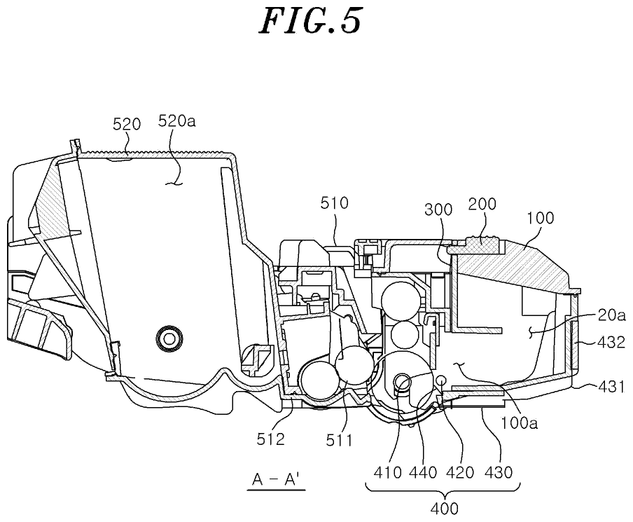

In this specification, expressions such as upper portion, upper surface, and the like are based on the illustration in the drawings. It is to be mentioned in advance that an object may be expressed differently if the direction of the object is changed. In addition, the front-rear direction may refer to the left-right direction in FIG. 5. As an example, a front side may refer to the right side in FIG. 5, and a rear side may refer to the left side in FIG. 3.

Hereinafter, an example of an image forming apparatus 1 will be described with reference to the drawings.

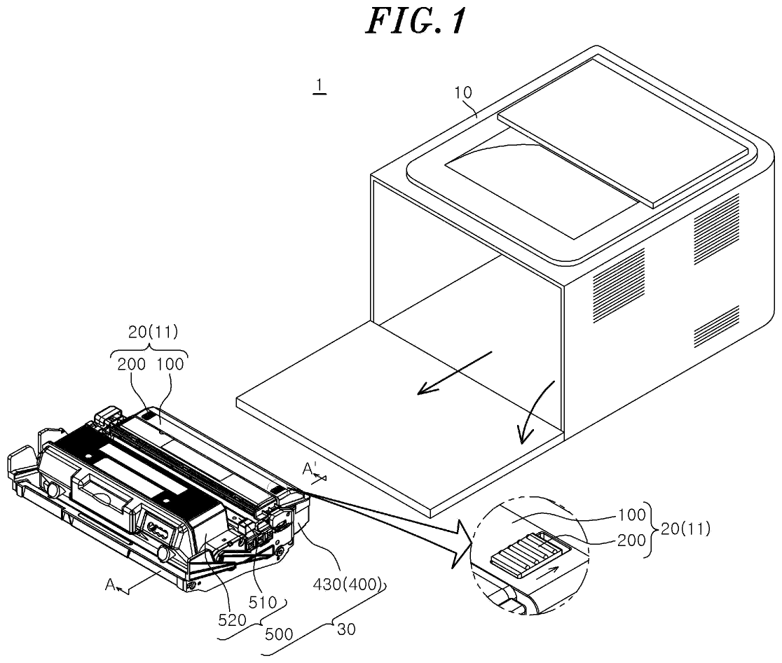

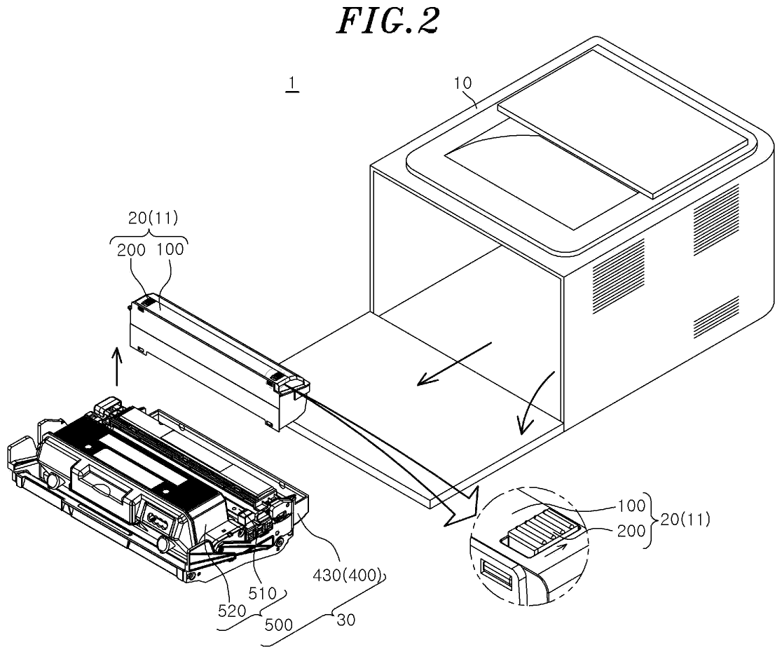

Referring to FIGS. 1 and 2, the image forming apparatus 1 may generate, print, receive, and transmit image data. For example, the image forming apparatus 1 may be a printer, a copier, a scanner, a fax machine, or a multi-function peripheral printer (MFP) that complexly implements functions of the printer, the copier, the scanner, and the fax machine through one apparatus. However, in the subject specification, the image forming apparatus 1 will be described as a printer for convenience and not by way of limitation.

The image forming apparatus 1 may print data generated by a terminal device such as a computer or the like on a printing medium such as paper or the like. The image forming apparatus 1 may include a case 10, and an image forming apparatus cartridge 11.

The case 10 may form an exterior of the image forming apparatus 1. A space to accommodate the image forming apparatus cartridge 11 may be formed in the case 10. In addition, the image forming apparatus cartridge 11 may be removably mounted on the case 10. For example, the user may remove the image forming apparatus cartridge 11 mounted on the case 10 and may replace it with another (e.g., a new) image forming apparatus cartridge 11. As an example, the user may open a cover provided on the case 10 and may move the image forming apparatus cartridge 11 rearward with respect to the case 10, whereby the case 10 and the image forming apparatus cartridge 11 can be separated from each other. Referring to FIG. 2, a waste toner storage part 20 of the image forming apparatus cartridge 11 separated from the case 10 may be removed from a frame 430, examples of which are described later. For example, the waste toner storage part 20 may be unlocked from the frame 430 through a lock part 200 and may be removed from the frame 430 after being unlocked from the frame 430.

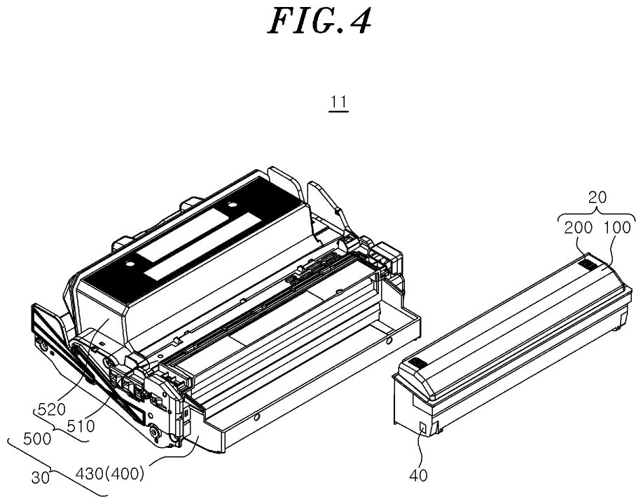

Referring to FIGS. 3 to 5, the image forming apparatus cartridge 11 may include the waste toner storage part 20, a cartridge module 30, a sensor 40, a photosensitive drum 410, a waste toner transfer part 420, the frame 430, and a cleaner. The waste toner storage part 20 may store waste toner that is generated by forming a toner image on a print medium. For example, the waste toner storage part 20 may store waste toner transferred through the waste toner transfer part 420, examples of which are described later. A waste toner storage space 20a to store waste toner may be formed in the waste toner storage part 20. The waste toner storage part 20 may be removably mounted to the cartridge module 30. For example, the waste toner storage part 20 may be removably formed in the frame 430, examples of which are described later. As a more detailed example, the waste toner storage part 20 may be removed from the cartridge module 30 after being removed from the case 10 together with the cartridge module 30.

The waste toner storage part 20 may be in a mounted state or a removed state. The mounted state may refer to a state in which the waste toner storage part 20 is mounted and supported on the cartridge module 30. In an example, as the waste toner storage part 20 is moved upward in the mounted state, the waste toner storage part 20 may be released from the mounted state.

The removed state may refer to a state in which the waste toner storage part 20 is removed from the cartridge module 30 without being supported and is spaced apart from the cartridge module 30. For example, the removed state may be a state in which the waste toner storage part 20 is moved upward by a preset distance from the mounted state so that the waste toner storage part 20 and the cartridge module 30 are spaced apart from each other. In this removed state, an opening 100a may be closed. The waste toner storage part 20 may include a metal, a plastic, or the like. The waste toner storage part 20 may include a body part 100, the lock part 200, an opening/closing member 300, and an elastic member.

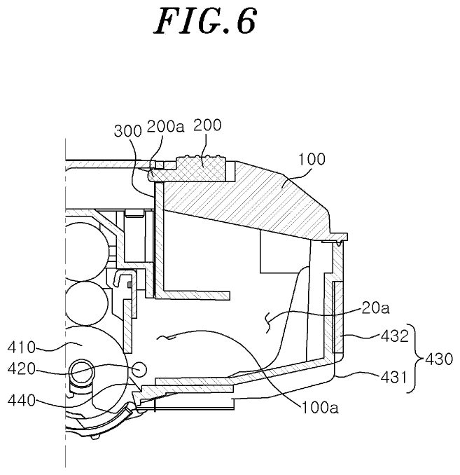

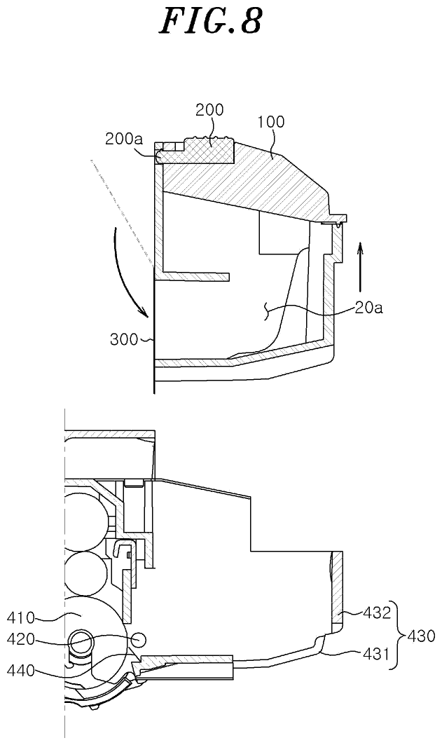

Referring to FIGS. 6 to 8, the body part 100 may support the lock part 200 and the opening/closing member 300. This body part 100 may be supported by the cartridge module 30 in the mounted state. The opening 100a to bring the waste toner storage part 20 and the cartridge module 30 into communication with each other may be formed in the body part 100. For example, in the mounted state, the cartridge module 30, the waste toner storage space 20a, and the opening 100a may communicate with each other. The waste toner generated in the cartridge module 30 may be transferred to the waste toner storage space 20a through the opening 100a.

The lock part 200 may selectively fasten the cartridge module 30 and the waste toner storage part 20 to each other. The lock part 200 may be movable, for example, in the front-rear direction. The lock part 200 may restrict or allow movement of the waste toner storage part 20 with respect to the cartridge module 30. The lock part 200 may be in a locked state or an unlocked state.

The locked state may be a state in which the lock part 200 locks the cartridge module 30 and the waste toner storage part 20 to each other. In the locked state, the movement of the waste toner storage part 20 with respect to the cartridge module 30 may be restricted. For example, in the locked state, the movement of the waste toner storage part 20 upward or forward with respect to the cartridge module 30 may be restricted. In other words, the locked state may be a state in which the mounted state is maintained.

The unlocked state may be a state in which the cartridge module 30 and the waste toner storage part 20 may be released by moving the lock part 200 forward from the locked state. In this unlocked state, the waste toner storage part 20 may be allowed to move with respect to the cartridge module 30. For example, in the unlocked state, the waste toner storage part 20 may be allowed to move upward or forward with respect to the cartridge module 30. In other words, the unlocked state may be a state that allows the mounted state to be switched to the removed state. In addition, in the unlocked state, rotation of the opening/closing member 300 may be allowed.

The lock part 200 may be disposed on the upper side of the body part 100. In an example, a plurality of lock parts 200 may be respectively arranged on left and right sides of the upper side of the body part 100 so as to be spaced apart from each other. A locking protrusion 200a protruding upward may be formed on the rear side of the lock part 200. The locking protrusion 200a may be inserted into a locking groove formed on the front upper side of the cartridge module 30. Such a locking groove may be, for example, a groove recessed upward on the front upper side of the cartridge module 30. For example, based on the locking protrusion 200a being inserted into the locking groove, the lock part 200 may be in the locked state.

In an example, the lock part 200 may be movable in the front-rear direction. For example, the lock part 200 may have a shape of a button that can be pressed downward. As a more detailed example, based on the lock part 200 being pressed downward, the lock part 200 may be in the locked state, and based on the pressure applied to the lock part 200 being released, the lock part 200 may be in the unlocked state.

As another example, the lock part 200 may be rotatable with respect to the body part 100. For example, the lock part 200 may be rotatable about a rotation axis extending along a left-right direction or an up-down direction. The lock part 200 may be arranged on both sides of the body part 100 (e.g., on the left and right sides of the body part 100).

Based on the insertion of the locking protrusion 200a into the locking groove being released, the lock part 200 may be in the unlocked state. For example, the insertion of the locking protrusion 200a into the locking groove may be released by moving the lock part 200 downward by a length at least as long as the protruding length of the locking protrusion 200a and moving the lock part 200 forward.

In an example, an elastic body may be provided at the lower end of the lock part 200. For example, the elastic body provided at the lower end of the lock part 200 may provide an upward elastic force to the lock part 200 based on the lock part 200 being moved downward by a length at least as long as the protruding length of the locking protrusion 200a.

In an example, an elastic body may be provided at the front end of the lock part 200. For example, the elastic body provided at the front end of the lock part 200 may provide a rearward elastic force to the lock part 200 based on the lock part 200 being moved forward by a preset distance. Such an elastic body may be, for example, a compression coil spring, an elastic rubber, or the like.

Referring to FIG. 6, the opening/closing member 300 may be in an open state to open the waste toner storage space 20a with respect to the cartridge module 30 so that the opening 100a is formed, or may be in a closed state to close the opening 100a. In the mounted state, the opening/closing member 300 may be in the open state. In addition, in the removed state, the opening/closing member 300 may be in the closed state.

One end of the opening/closing member 300 may extend along one direction. The one direction may be, for example, the left-right direction perpendicular to the front-rear direction and the up-down direction. The one end of the opening/closing member 300 may be rotatably connected to the body part 100. The one end of the opening/closing member 300 may be, for example, a lower end of the opening/closing member 300 in the open state. Furthermore, the one end of the opening/closing member 300 may be an upper end of the opening/closing member 300 in the closed state. The opening/closing member 300 may be oriented in the up-down direction so that the one end thereof is disposed below the other end in the mounted state.

In addition, the other end of the opening/closing member 300 may be rotatable with respect to the body part 100 about an opening/closing rotation axis provided at the one end of the opening/closing member 300. The opening/closing rotation axis provided at the one end of the opening/closing member 300 may be a virtual straight line extending along one direction. The other end of the opening/closing member 300 refers to an end opposite to the one end and may be the upper end of the opening/closing member 300 in the open state. Furthermore, the other end of the opening/closing member 300 may be the lower end of the opening/closing member 300 in the closed state. The opening/closing member 300 may be oriented in the up-down direction so that the one end thereof is disposed above the other end in the removed state.

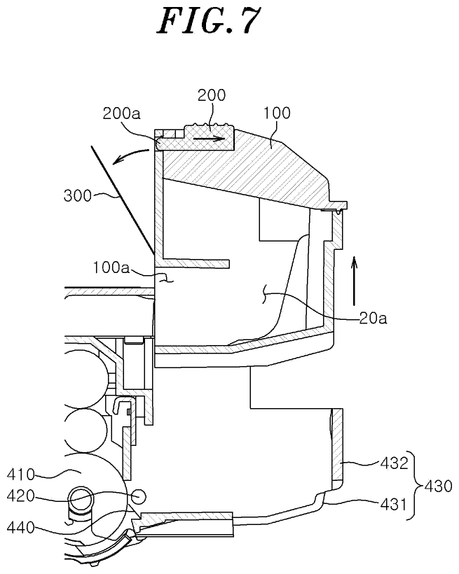

Based on being switched between the mounted state and the removed state, the opening/closing member 300 may be rotated about the opening/closing rotation axis provided at the one end of the opening/closing member 300 so that the one end of the opening/closing member 300 approaches the ground. For example, the opening/closing member 300 may be rotated counterclockwise in FIG. 7 based on being switched between the mounted state and the removed state. The opening/closing member 300 may be rotated by its own weight, for example, based on being switched between the mounted state and the removed state. In other words, even if a separate external force is not applied to the opening/closing member 300, the opening/closing member 300 may be rotated by gravity. As another example, the opening/closing member 300 may be rotated by the elastic force provided by the elastic member. For example, the opening/closing member 300 may be switchable between the open state and the closed state through the elastic force provided by the elastic member.

Based on the opening/closing member 300 being in the mounted state, interference prevention holes may be formed at the upper left and right portions. For example, based on the opening/closing member 300 being in the mounted state, the lock part 200 may be inserted into the interference prevention holes so that the upper end of the opening/closing member 300 does not interfere with the lock part 200.

The elastic member may provide an elastic force to the opening/closing member 300 in a direction in which the opening/closing member 300 gets out of the open state. For example, based on the opening/closing member 300 being in the open state, the elastic member may apply a rearward elastic force to the opening/closing member 300 in the mounted state. Such an elastic member may be, for example, a torsion spring. Such an elastic member may be disposed adjacent to the one end of the opening/closing member 300, and both ends thereof may be connected to the body part 100 and the opening/closing member 300, respectively.

The cartridge module 30 may form a toner image on a print medium. The cartridge module 30 may generate waste toner after forming the toner image on the print medium.

The sensor 40 may detect an amount of waste toner stored in the waste toner storage space 20a. The sensor 40 may include an infrared sensor, an ultrasonic sensor, a light window, and the like. The sensor 40 may be disposed adjacent to the waste toner storage space 20a.

An electrostatic latent image may be formed on the photosensitive drum 410. The electrostatic latent image may be formed on the photosensitive drum 410 by an operation of a charger and an exposure device. The charger may charge the surface of the photosensitive drum 410 with a uniform electric potential. The exposure device may form the electrostatic latent image on the surface of the photosensitive drum 410 by changing the surface potential of the photosensitive drum 410 according to the image information to be printed.

The waste toner transfer part 420 may transfer the waste toner generated based on the toner image being formed on the print medium to the waste toner storage part 20. The waste toner transfer part 420 may be rotated about a transfer rotation axis to transfer the waste toner to the waste toner storage part 20. The transfer rotation axis may be a virtual straight line extending along a direction (e.g., the left-right direction) perpendicular to the waste toner transfer direction and the up-down direction. The waste toner transfer part 420 may extend along the left-right direction to be disposed adjacent to the photosensitive drum 410. The waste toner transfer part 420 may have, for example, a shape of an auger including a shaft extending along the left-right direction and a helical blade. In addition, the waste toner transfer part 420 may be driven by a motor.

Referring to FIG. 7, the frame 430 may support the waste toner storage part 20 based on the waste toner storage part 20 being in the mounted state. An accommodation space to accommodate the waste toner storage part 20 may be formed in the frame 430. The frame 430 may include a tray 431 and a separation part 432.

The tray 431 may support the lower portion of the waste toner storage part 20 in the mounted state. The tray 431 may have an upwardly opened shape. In other words, the waste toner storage part 20 may be moved upward with respect to the tray 431 so that it can be out of the mounted state.

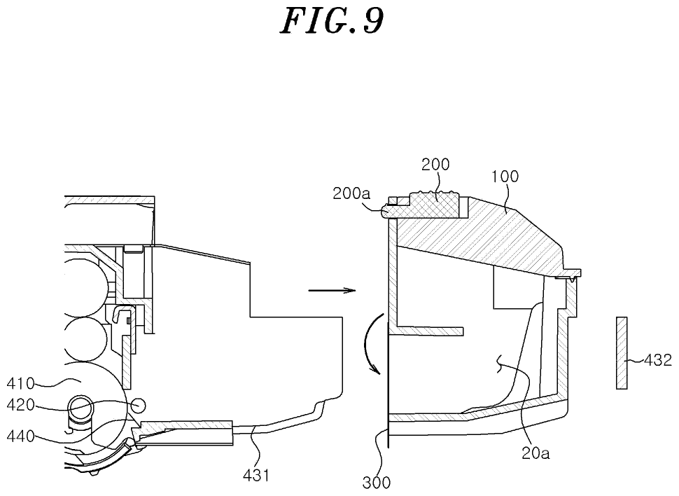

Referring to FIG. 9, the separation part 432 may be removably connected to one end of the tray 431. For example, the separation part 432 may be removably connected to the front end of the tray 431. Based on the separation part 432 being connected to one end of the tray 431, the separation part 432 may limit movement of the waste toner storage part 20 accommodated in the accommodation space in the front-rear direction.

Based on the separation part 432 being separated from the tray 431, the separation part 432 may allow the waste toner storage part 20 to move in the front-rear direction. In other words, based on the separation part 432 being separated from the tray 431, the waste toner storage part 20 may be moved in the up-down direction or the front-rear direction to be removed from the mounted state.

A cleaner 440 may be formed to remove toner from the outer circumferential surface of the photosensitive drum 410. The cleaner 440 may be arranged adjacent to the photosensitive drum 410. For example, the cleaner 440 may be disposed in front of the photosensitive drum 410 and may be disposed behind the waste toner transfer part 420.

The waste toner removed by the cleaner 440 may be transferred by the waste toner transfer part 420. The waste toner removed by the cleaner 440 may be transferred from the photosensitive drum 410 toward the waste toner storage part 20 by the waste toner transfer part 420. The direction from the photosensitive drum 410 toward the waste toner storage part 20 may be, for example, a forward direction.

The cleaner 440 may be disposed below the waste toner transfer part 420. For example, the waste toner removed by the cleaner 440 may be loaded on the upper side of the cleaner 440, and the loaded waste toner may be transferred to the waste toner storage part 20 by the waste toner transfer part 420.

However, examples of the present disclosure are limited thereto. The cleaner 440 may be disposed above the waste toner transfer part 420. In this case, the waste toner removed by the cleaner 440 may be loaded below the cleaner 440.

Hereinafter, example operations and effects of the image forming apparatus 1 will be described.

The cleaner 440 of the image forming apparatus 1 may remove toner from the outer circumferential surface of the photosensitive drum 410. The removed toner may be transferred from a photosensitive cartridge 400 through the opening 100a to the waste toner transfer space 20a by the waste toner transfer part 420. The user may check the amount of waste toner stored in the waste toner storage space 20a through the sensor 40. Based on the amount of waste toner stored in the waste toner storage space 20a exceeding a predetermined amount, the waste toner storage part 20 may be separated from the cartridge module 30 and the waste toner stored in the waste toner storage space 20a may be discharged to the outside.

Hereinafter, an example process in which the waste toner storage part 20 is separated from the cartridge module 30 will be described. The case 10 and the image forming apparatus cartridge 11 may be separated from each other. The waste toner storage part 20 of the image forming apparatus cartridge 11 separated from the case 10 may be removed from the cartridge module 30. Based on the lock part 200 being moved downward by the protruding length of the locking protrusion 200a with respect to the body part 100 in the mounted state, the insertion of the locking protrusion 200a into the locking groove may be released.

Thereafter, the lock part 200 may be moved forward by a predetermined distance with respect to the body part 100, whereby the waste toner storage part 20 and the cartridge module 30 may be unlocked.

Thereafter, based on the waste toner storage part 20 being moved upward or forward with respect to the cartridge module 30, it may be removed from the mounted state. While the waste toner storage part 20 is removed from the mounted state, the opening/closing member 300 may be rotated about the opening/closing rotation axis. For example, the other end of the opening/closing member 300 may be rotated in a direction in which it approaches the ground.

Based on the waste toner storage part 20 being moved upward or forward by a predetermined distance with respect to the cartridge module 30 and being spaced apart from the cartridge module 30, the waste toner storage part 20 may be in the removed state. Based on the waste toner storage part 20 being switched between the mounted state and the removed state, the opening/closing member 300 may be in a closed state to close the opening 100a. Accordingly, while being in the removed state, the waste toner stored in the waste toner storage space 20a may be prevented from leaking to the outside as the opening/closing member 300 is switched to the closed state. The waste toner storage part 20 may be separated from the cartridge module 30 while the opening/closing member 300 is kept in the closed state.

In an example, the waste toner storage part 20 can be replaced without replacing the entire image forming apparatus cartridge 11, thereby prolonging the lifespan of the cartridge module 30. In other words, there is an effect that the user can use the cartridge module 30 of the image forming apparatus 1 until the cartridge module 30 reaches the maximum lifespan, thereby saving unnecessary cost for replacement of the cartridge module 30.

In addition, the image forming apparatus 1 has an effect that since the user can replace the waste toner storage part 20 at a user's desired moment, it is possible to prevent the inside of the case 10 from being contaminated due to the long-term storage of the waste toner in the waste toner storage space 20a.

In addition, the image forming apparatus 1 has an effect that, via the opening/closing member 300 rotated by its own weight or the elastic force of the elastic member, it can prevent the waste toner from scattering based on the waste toner storage part 20 being removed from the cartridge module 30.

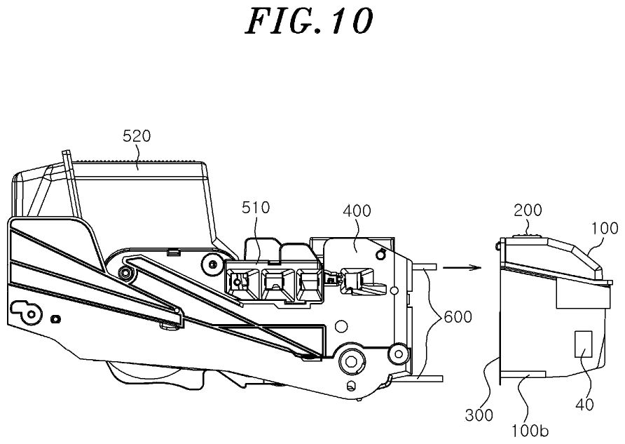

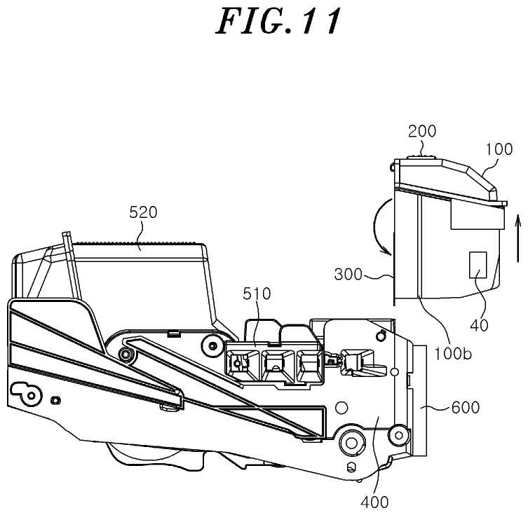

In an example, the frame 430 may not include the tray 431 and the separation part 432, and the cartridge module 30 may include an assembly guide 600. Hereinafter, an example of the frame 430 including the assembly guide 600 will be described with reference to FIGS. 10 and 11. In the following description, differences from the above-described examples are mainly described. The description and reference numerals of the above-described examples are incorporated here by reference.

The assembly guide 600 may guide the movement of the waste toner storage part 20. The assembly guide 600 may be arranged on a front side of the photosensitive cartridge 400. The assembly guide 600 may extend along a direction in which the waste toner storage part 20 is removed from the cartridge module 30.

The direction in which the waste toner storage part 20 is removed from the cartridge module 30 may be, for example, the up-down direction. In other words, the assembly guide 600 may extend along the up-down direction. However, the examples are not so limited thereto. The direction in which the waste toner storage part 20 is removed from the cartridge module 30 may be a front-rear direction. In other words, the assembly guide 600 may extend along the front-rear direction. The assembly guide 600 may support the waste toner storage part 20 based on the waste toner storage part 20 being in the mounted state.

In addition, a guide groove 100b to engage with the assembly guide 600 may be formed in the body part 100. The guide groove 100b may be a slot extending in a direction parallel to the direction in which the assembly guide 600 extends. For example, if the extension direction of the assembly guide 600 is the up-down direction, the guide groove 100b may be a slot extending in the up-down direction. As a more detailed example, in the removed state, the upper end of the assembly guide 600 and the lower end of the guide groove 100b may be vertically spaced apart from each other.

As another example, based on the direction in which the assembly guide 600 extends being the front-rear direction, the guide groove 100b may be a slot extending in the front-rear direction. As a more detailed example, in the removed state, the front end of the assembly guide 600 and the rear end of the guide groove 100b may be spaced apart from each other back and forth.

In addition, the waste toner storage part 20 may be slidably movable in the up-down direction or the front-rear direction in a state in which the guide groove 100b and the assembly guide 600 are engaged. For example, a roller or the like may be provided between the guide groove 100b and the assembly guide 600. Through this roller, the waste toner storage part 20 may be moved relative to the photosensitive cartridge 400 in a sliding manner.

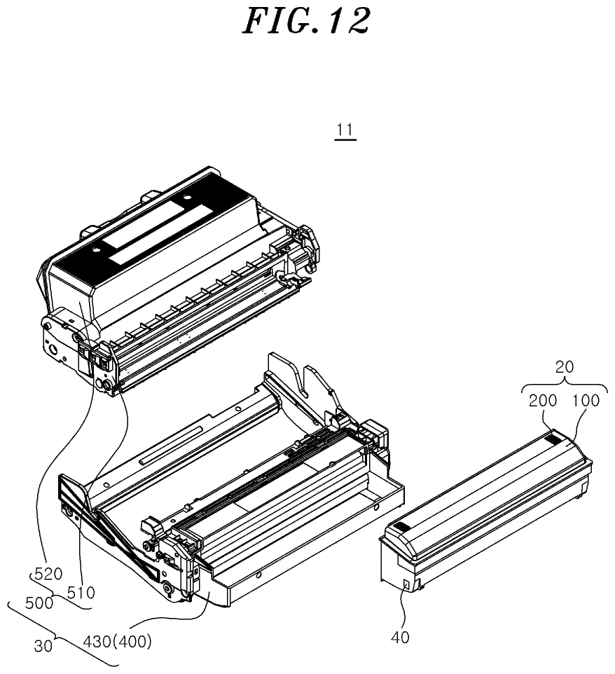

In an example, the cartridge module 30 may include the photosensitive cartridge 400 and a cartridge assembly 500. Hereinafter, an example of the cartridge module 30 including the photosensitive cartridge 400 and the cartridge assembly 500 will be described with reference to FIG. 12. In the following description, differences from the above-described examples are mainly described. The description and reference numerals of the above-described examples are incorporated here by reference.

The photosensitive cartridge 400 may form an electrostatic latent image. The waste toner storage part 20 may be removably mounted on one side of the photosensitive cartridge 400. The photosensitive cartridge 400 may include the photosensitive drum 410, the waste toner transfer part 420, the frame 430, and the cleaner 440.

The cartridge assembly 500 may supply toner to the electrostatic latent image formed by the photosensitive cartridge 400. The cartridge assembly 500 may include a developing cartridge 510. The developing cartridge 510 may be removably mounted on the photosensitive cartridge 400. For example, the waste toner storage part 20 may be removably mounted on one side of the photosensitive cartridge 400, and the developing cartridge 510 may be removably mounted on the other side of the photosensitive cartridge 400.

One side of the photosensitive cartridge 400 may be, for example, a front side of the photosensitive cartridge 400, and the other side of the photosensitive cartridge 400 may be, for example, a rear side of the photosensitive cartridge 400. Referring to FIG. 5, the developing cartridge 510 may include a developing roller 511 and a developing frame 512 to accommodate the developing roller 511 and a developer.

The developing roller 511 may supply the developer (e.g., toner) to the electrostatic latent image formed on the photosensitive drum 410. The developing roller 511 may be arranged adjacent to the photosensitive drum 410 based on the developing cartridge 510 being mounted on the photosensitive cartridge 400.

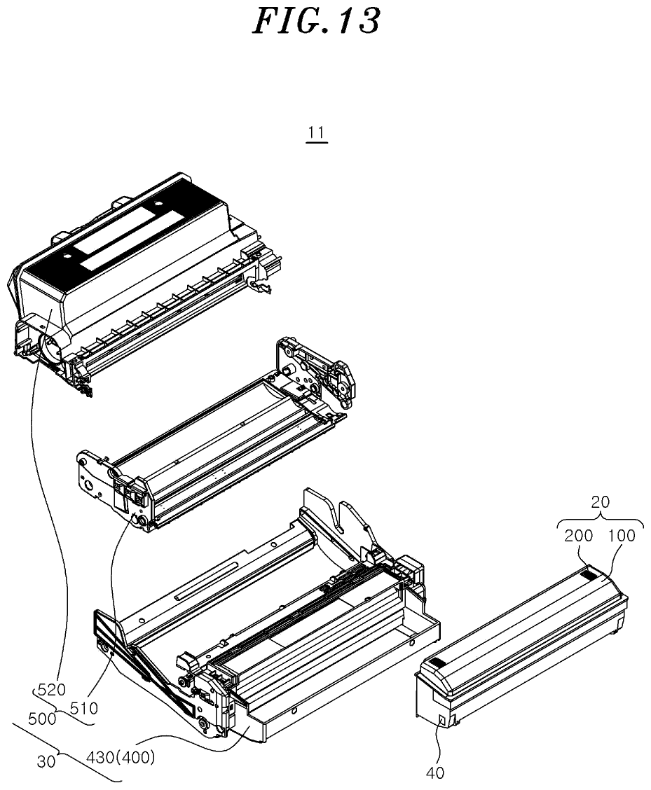

In an example, the cartridge assembly 500 may further include a toner cartridge 520. Hereinafter, an example of the cartridge assembly 500 including the toner cartridge 520 be described with reference to FIG. 13. In the following description, differences from the above-described examples are mainly described. The description and reference numerals of the above-described examples are incorporated here by reference.

The toner cartridge 520 may be removably mounted on the photosensitive cartridge 400 or the developing cartridge 510. In other words, the toner cartridge 520, the photosensitive cartridge 400, and the developing cartridge 510 may be separate members that can be separated from each other. Furthermore, the developing cartridge 510, the toner cartridge 520, the photosensitive cartridge 400, and the waste toner storage part 20 may be separate members that can be separated from each other. As illustrated in FIG. 5, the toner cartridge 520 may provide a toner storage space 520a to store toner to be supplied to the photosensitive drum 410.

While examples of the present disclosure have been described, the present disclosure is not limited thereto and should be construed as having the widest scope within the technical spirit disclosed in the present specification. The present disclosure may be implemented in a form that is not included in the above described examples by combining or replacing the disclosed examples, however, it also does not depart from the scope of the present disclosure. In addition, it is apparent that the disclosed examples may be changed or modified based on the present specification, and thus, such changes or modifications fall within the scope of the present disclosure.

What is claimed is:

1. A cartridge for an image forming apparatus, the cartridge comprising:
a frame;
a photosensitive drum accommodated in the frame;
a cleaner to remove toner from an outer circumferential surface of the photosensitive drum;
a waste toner transfer part to transfer waste toner removed by the cleaner; and
a waste toner storage part, removably mounted on the frame, to store the waste toner transferred through the waste toner transfer part.

2. The cartridge of claim 1, wherein the waste toner storage part includes:
a body part having an opening to bring the waste toner storage part and the frame into communication with each other in a mounted state in which the waste toner storage part is mounted on the frame; and
an opening/closing member to close the opening in a removed state in which the waste toner storage part is removed from the frame.

3. The cartridge of claim 2,
wherein the waste toner storage part is movable out of the mounted state as the waste toner storage part is moved upward in the mounted state in which the waste toner storage part is mounted on the frame, and is to be in the removed state based on the waste toner storage part being moved upward from the mounted state by a preset distance to be spaced apart from the frame, and
wherein the waste toner storage part includes a body part, and an opening/closing member to, in the mounted state, be in an open state and oriented in an up-down direction having one end thereof disposed below another end thereof, to, in the removed state, be in a closed state and oriented in the up-down direction having the one end thereof disposed above the other end thereof, and to, based on the mounted state being switched to the removed state, be rotated with respect to the body part so that the other end is disposed below the one end.

4. The cartridge of claim 1, wherein the waste toner storage part includes a lock part to, based on the waste toner storage part being mounted on the frame, be in a locked state to restrict movement of the waste toner storage part with respect to the frame, or be in an unlocked state to allow movement of the waste toner storage part with respect to the frame from the locked state.

5. The cartridge of claim 4, wherein the waste toner storage part is to be separated from the frame by moving in at least one of an up-down direction or a front-rear direction.

6. The cartridge of claim 1, wherein the waste toner storage part is to, based on the waste toner storage part being mounted on the frame, be disposed behind a front end of the frame and be disposed in front of the photosensitive drum.

7. The cartridge of claim 1, further comprising:
an assembly guide extending along a direction in which the waste toner storage part is removed from the frame to guide movement of the waste toner storage part.

8. A cartridge for an image forming apparatus, the cartridge comprising:
a photosensitive cartridge including a photosensitive drum, a cleaner to remove toner from an outer circumferential surface of the photosensitive drum, and a waste toner transfer part to transfer waste toner removed by the cleaner;
a developing cartridge removably mounted on the photosensitive cartridge and including a developing roller, the developing roller being adjacent to the photosensitive drum based on the developing cartridge being mounted on the photosensitive cartridge; and
a waste toner storage part, removably mounted on the photosensitive cartridge, to store the waste toner transferred through the waste toner transfer part.

9. The cartridge of claim 8,
wherein the photosensitive cartridge further includes a frame having an accommodation space on a front side thereof to accommodate the waste toner storage part,
wherein the waste toner storage part is accommodated in the accommodation space based on the waste toner storage part being mounted on the photosensitive cartridge, and
wherein the developing cartridge mounted on the photosensitive cartridge is disposed behind the accommodation space.

10. The cartridge of claim 8, wherein the waste toner storage part includes a lock part to, based on the waste toner storage part being mounted on the photosensitive cartridge, be in a locked state to restrict movement of the waste toner storage part with respect to the photosensitive cartridge, or be in an unlocked state to allow movement of the waste toner storage part with respect to the photosensitive cartridge from the locked state.

11. The cartridge of claim 8,
wherein the waste toner storage part is movable out of a mounted state as the waste toner storage part is moved upward in the mounted state in which the waste toner storage part is mounted on the photosensitive cartridge, and is to be in a removed state based on the waste toner storage part being moved upward from the mounted state by a preset distance to be spaced apart from the photosensitive cartridge, and
wherein the waste toner storage part includes a body part, and an opening/closing member to, in the mounted state, be in an open state and oriented in an up-down direction having one end thereof disposed below another end thereof, to, in the removed state, be in a closed state and oriented in the up-down direction having one end thereof disposed above the other end thereof, and to, based on the mounted state being switched to the removed state, be rotated about an opening/closing rotation axis with respect to the body part so that the other end is disposed below the one end.

12. A cartridge for an image forming apparatus, the cartridge comprising:
a photosensitive cartridge including a photosensitive drum, a cleaner to remove toner from an outer circumferential surface of the photosensitive drum, and a waste toner transfer part to transfer waste toner removed by the cleaner;
a developing cartridge removably mounted on the photosensitive cartridge and including a developing roller, the developing roller being adjacent to the photosensitive drum based on the developing cartridge being mounted on the photosensitive cartridge;
a toner cartridge, removably mounted on the photosensitive cartridge or the developing cartridge, to provide a toner storage space to store toner to be supplied to the photosensitive drum; and
a waste toner storage part, removably mounted on the photosensitive cartridge, to store the waste toner transferred through the waste toner transfer part.

13. The cartridge of claim 12,
wherein the photosensitive cartridge further includes a frame having an accommodation space formed on a front side thereof to accommodate the waste toner storage part,
wherein the waste toner storage part is accommodated in the accommodation space based on the waste toner storage part being mounted on the photosensitive cartridge,
wherein the developing cartridge mounted on the photosensitive cartridge is disposed behind the accommodation space, and
wherein the toner storage space is disposed behind the developing cartridge mounted on the photosensitive cartridge based on the toner cartridge being mounted on the photosensitive cartridge or the developing cartridge.

14. The cartridge of claim 12, wherein the waste toner storage part includes a lock part to, based on the waste toner storage part being fastened to the photosensitive cartridge, be in a locked state to restrict movement of the waste toner storage part with respect to the photosensitive cartridge, or be in an unlocked state to allow movement of the waste toner storage part with respect to the photosensitive cartridge from the locked state.

15. The cartridge of claim 12, wherein the waste toner storage part is movable out of a mounted state as the waste toner storage part is moved upward in the mounted state in which the waste toner storage part is mounted on the photosensitive cartridge, and is to be in a removed state based on the waste toner storage part being moved upward from the mounted state by a preset distance so as to be spaced apart from the photosensitive cartridge, and
the waste toner storage part includes a body part, and an opening/closing member to, in the mounted state, be in an open state and oriented in an up-down direction so that one end thereof is disposed below another end thereof, to, in the removed state, be in a closed state and oriented in the up-down direction so that one end thereof is disposed above the other end thereof, and to, based on the mounted state being switched to the removed state, be rotated about an opening/closing rotation axis with respect to the body part so that the other end is disposed below the one end.
